(19) United States
(12) Patent Application Publication
(10) Pub. No.: US 2014/0129366 A1
(43) Pub. Date: May 8, 2014

(54) SELF-SERVICE REAL ESTATE FRAMEWORK

(71) Applicant: Charanjit MUDHAR, Tracy, CA (US)

(72) Inventor: Charanjit MUDHAR, Tracy, CA (US)

(21) Appl. No.: 14/038,471

(22) Filed: Sep. 26, 2013

Related U.S. Application Data
(60) Provisional application No. 61/716,132, filed on Oct. 19, 2012.

(51) Int. Cl. G06Q 50/16; G06Q 30/06

(52) U.S. Cl. CPC G06Q 50/167; G06Q 30/0611
USPC 705/26.4

(57) ABSTRACT

A system for providing transparency in a real estate transaction is provided that allows buyers and sellers of real property to interact with each other legally, safely, and efficiently without requiring a traditional real estate agent. Sellers interact with the system to create listings, accept offers, make counter-offers, and hire experts as needed. Buyers interact with the system to find listings, make offers and counter-offers, and hire experts as needed. The system may have an integrated connection with platform partners that provide services such as seller authentication, advertising, or payment processing. Service providers may interact with the system to offer services relevant to a real estate transaction such as home inspection, repair, real estate legal counseling, lending, title search, or escrow services. Service providers may receive requests for quotes for service from buyers and sellers through the system, respond with bids, be awarded work, and paid though the system.

### CROSS REFERENCE TO RELATED APPLICATIONS

This claims priority to provisional U.S. patent application Ser. No. 61/716,132, filed Oct. 19, 2012, the entirety of which is incorporated herein by this reference thereto.

### BACKGROUND OF THE INVENTION

1. Field of the Invention

The invention relates to buying and selling real estate. More particularly, the invention concerns a framework for buyers and sellers of real property to enter into a contract and transfer property safely and without relying on or paying commission to a real estate agent or broker.

2. Description of the Related Art

Selling real property to a buyer is usually facilitated by a Real Estate Agent (REA). A REA representing the seller provides services such as placing a description of the property in a multiple listing service (MLS), advertising the property, showing a house during an open house, receiving offers from the buyer's REA, presenting offers to the seller, providing advice to the sellers, representing the sellers in negotiations with buyers, arranging other service providers such as Title Company, Escrow company, inspections, etc. A REA with experience has connections with service providers that have proven trustworthy in the past, and these service providers have a vested interest in keeping the REA happy in the interest of receiving future business. Identifying and recommending a reliable service provider may be a valuable service provided by a REA.

A buyer's REA filters the houses on the MLS or other source of property advertisements according to the criteria provider by the buyers, takes the buyers on tours of the properties meeting the criteria, writes offers, and represents the buyers in negotiations regarding the purchase agreement with the seller's REA. The REA's are compensated for their service by a commission on the sale of the property. A typical sales commission is 6% (3% for the seller's REA and 3% for the buyer's REA).

Buying/selling property through a REA removes the burden from the seller and buyer to perform the duties mentioned above, especially when buyer and seller have their own full time jobs. Much of what needs to be done is performed during normal business hours when many people are unavailable while attending to their own job. Also, a REA provides expertise for every aspect of the sales transaction that the average buyer and seller do not have.

However, there are also disadvantages of working with a REA. With real estate prices being very high, the commission represents an enormous amount of money—probably more than many people are comfortable spending for the services that are provided. Another disadvantage is that there may be a conflict of interest between the REA and the represented party. An REA's motivation is to make a quick sale, earn their commission, and move on. A quick and easy sale is not necessarily one that will bring in the highest price for a seller or the lowest price for a buyer. The filtering of offers provided by the REA may result in the seller only seeing that subset of offers that serves the interest of the agent, and other offers better for the seller might not be presented. Similarly, even though other properties might meet the buyer's desired criteria better, a buyer's agent might only show houses being sold by sellers who are particularly motivated, offering full commission, or requiring fewer contingencies. As a result of these issues, some sellers try to sell their property on their own, without the use of a REA.

There are few tools that help a seller sell property without the help of an agent. The primary service available today is advertising. Websites exist where properties can be advertised as FOR-SALE-BY-OWNER. However, these websites and other advertising services do not support the creation of an offer, purchase agreement, removal of contingencies, or close of sale. These tasks that would otherwise be performed by an agent fall to the sellers and buyers to perform themselves.

What's needed are tools to support FOR-SALE-BY-OWNER with support for the entire spectrum of tasks involved in a property sales transaction, from advertising to close of escrow.

### SUMMARY OF THE INVENTION

A self-service real estate framework provides tools for buyers and sellers to unbundle the package of services normally paid for through commission, and enable buyers and sellers to pay a reasonable price and have complete control over selecting service providers for just those individual services that they need. For example, a buyer or a seller may want to pay a fixed fee to a REA for consulting with them regarding market price, so that the consulting REA has no vested interest in information being provided. The framework may facilitate making connections (active communication) between buyers and sellers and between buyers/sellers and service providers. The framework forms a marketplace where service providers can advertise and be rated by previous customers. Service providers may be selected based on their reputation for previous customer satisfaction rather than by association with a REA.

The framework provides a written record of all activities (user actions and communications) involved in the sale, and the record is accessible to the parties involved in the sale. For example, a seller may see all offers and a buyer may see all properties that meet their criteria. At the same time, the framework may preserve needed privacy. For example, one buyer may not be allowed to view bids made by other buyers. The framework leverages the use of technology to make certain tasks easier for busy people. The use of electronic messaging and written record allows asynchronous communications among people with different schedules.

The platform provides a workflow for the lifecycle of a real estate sales transaction that includes the management of virtual objects representing real-world documents such as listings, offers, purchase agreements, and deeds.

### BRIEF DESCRIPTION OF THE DRAWINGS

FIG. 1 is a block diagram of the components and interconnections of a self service real estate framework, according to an embodiment of the invention.

FIG. 2 is a high level transition diagram showing the state transitions of a property transfer transaction, according to an embodiment of the invention.

FIG. 3 is an example screenshot of a tool user interface for creating a property listings and offers.

FIG. 4a is an example screenshot of a search interface for searching for property listings.

FIG. 4b is an example screenshot of search results for a buyer searching for listings, according to an embodiment of the invention.

FIG. 4c is an example screenshot of a user interface form for creating and updating an offer for a listed property, according to an embodiment of the invention.

FIG. 4d is an example screenshot of a buyer's user interface form for managing one or more offers, according to an embodiment of the invention.

FIG. 5 is an example screenshot of a seller's user interface form for presenting one or more offers for a listed property, according to an embodiment of the invention.

FIGS. 6a, 6b, and 6c are example screenshots of user interface forms for creating a service work order and selecting a service provider, according to an embodiment of the invention.

FIG. 7 is an example screenshot of a user interface form that displays a list of documents associated with a particular real estate transaction, according to an embodiment of the invention.

FIG. 8 is an example screenshot of a user interface form that displays a list of disclosures (disclosed by seller) associated with a particular real estate transaction, according to an embodiment of the invention.

FIG. 9 is an example screenshot of a service provider user interface to manage and control services offered by a service provider, according to an embodiment of the invention.

FIG. 10 is a block schematic diagram of a machine, according to an embodiment of the invention.

FIG. 11 is an object model, according to an embodiment of the invention.

FIG. 12 is an example flow diagram showing the interaction among multiple parties to a real estate transaction, according to an embodiment of the invention.

### DETAILED DESCRIPTION

The nature, objectives, and advantages of the invention will become more apparent to those skilled in the art after considering the following detailed description in connection with the accompanying drawings.

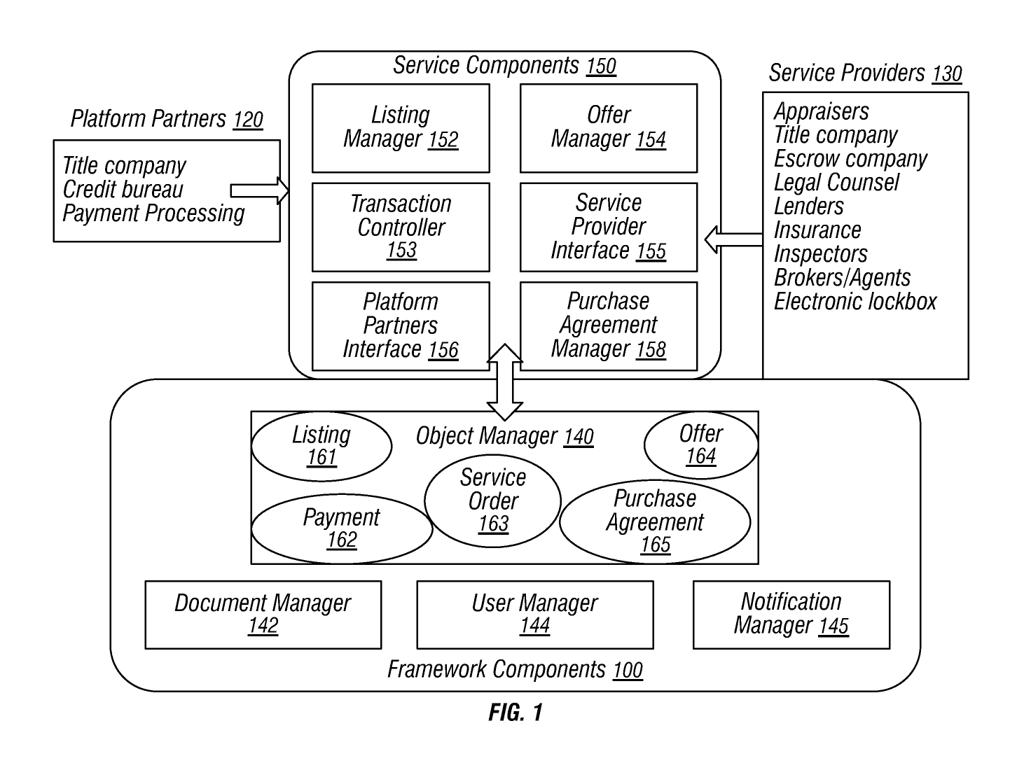

FIG. 1 is a block diagram of some of the components and interconnections of a self-service real estate framework, according to an embodiment of the invention. A system built according to the framework depicted in FIG. 1 may comprise a Document Manager 142, a User Manager 144, a Notification Manager 145, an Object Manager 140, Listing Manager 152, Transaction Controller 153, Platform Partner Interface 156, Offer Manager 154, Service Provider Interface 155, and Purchase Agreement Manager 158.

Document Manager 142: The document manager 142 provides creation, update, storage, retrieval, and version control of documents associated with the real estate transaction. Many of these documents are legal documents such as the Purchase Agreement, contracts signed by service providers, or deed of Trust. Other documents may include inspection reports, appraisal reports, title reports, etc.

User Manager 144: The user manager maintains account information for users of the system. Some of the roles supported by the user manager may include seller, buyer, and service provider. In an embodiment, the service provider role may be fine grained such as title service provider, contractor, lender, property insurance agent, etc. It is very important that appropriate access only be granted to those who have a need/right to see or change (take action) information in the system, so authentication is very important. Authentication and authorization may be provided by any known means.

Notification Manager 145: The Notification Manager sends notifications of events to the users affected by the event, such as notifying a prospective buyer that a new listing is published when a seller adds a property, or notifying a buyer when a seller accepts buyer's offer. In an embodiment, it may only notify that an event has occurred without providing details that may need to be secured. The notification manager 145 may interact with the user manager to maintain security and privacy of the communication and to ensure that only authorized recipients are allowed to view/read and respond to the notification.

Object Manager 140: The object manager provides life cycle support and maintains object state, for objects representing real world objects involved in the real estate transaction. Examples of such objects include a listing object 161, payment object 162, offer object 164, service order object 163, and purchase agreement object 165. Some objects are associated with documents managed by the document manager. For example, a purchase agreement object may track the current state of a real estate transaction stored in an electronic data structure, and the purchase agreement document may be a textual representation of a legal document. The object manager may support object creation, update, and access control based on user's role in the transaction, as well as generate an evert when the object undergoes a state transition. Just as the real estate transaction as a whole is associated with a state machine, each individual object may also define object states and have rules for transitioning from one state to another.

For example, when all contingencies associated with a purchase agreement are fulfilled/removed, an event may be triggered/generated that all requirements are met. Similarly, the object manager may support an object receiving an event notification from another object, and change the state of the receiving object accordingly. For example, a purchase agreement object factory may receive notification that an offer is accepted, in response, create a new purchase agreement object.

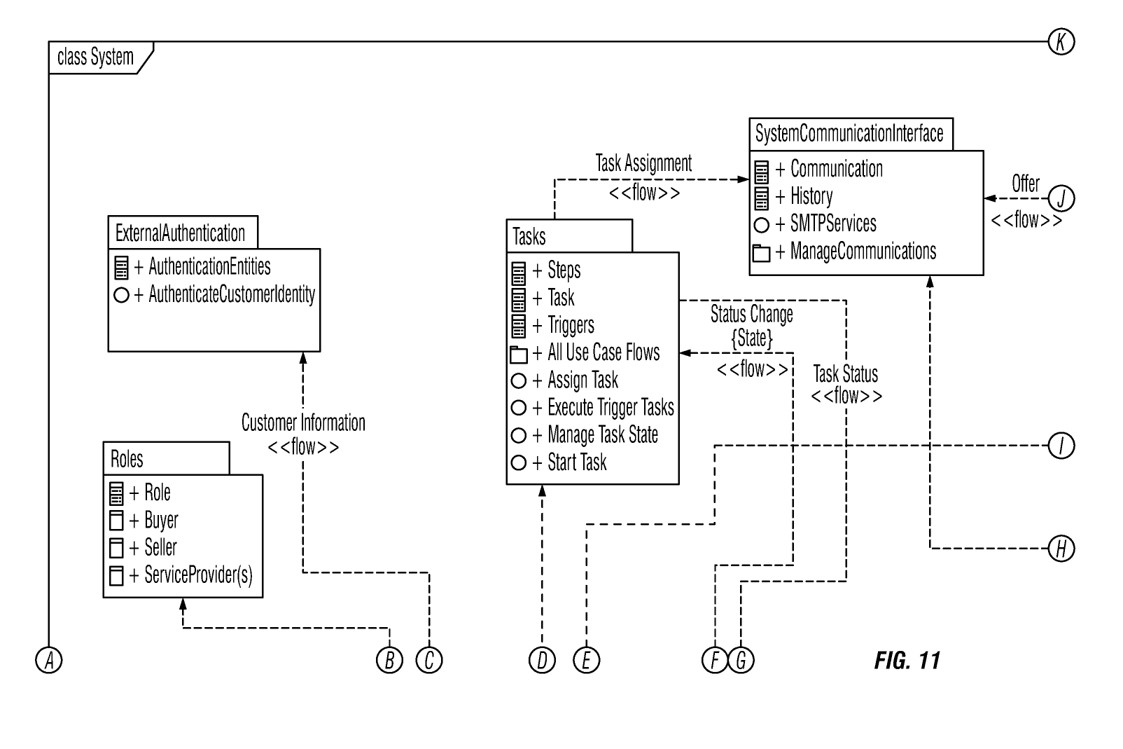

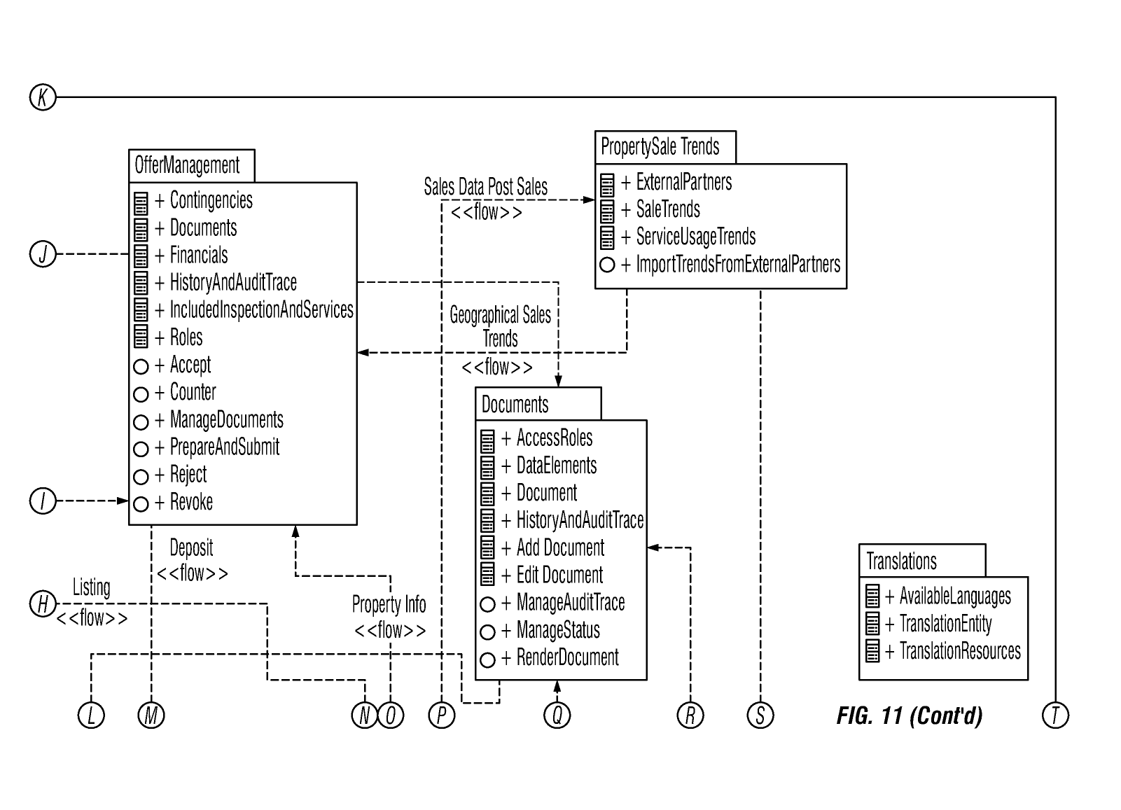

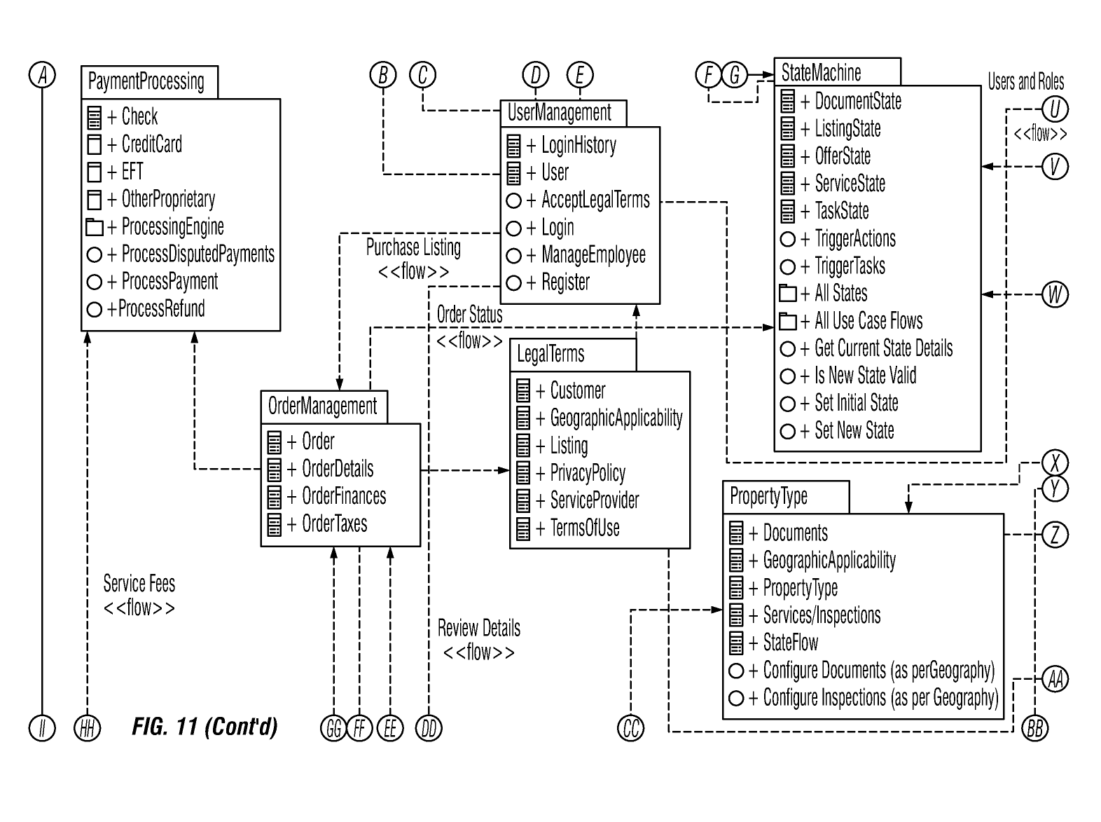

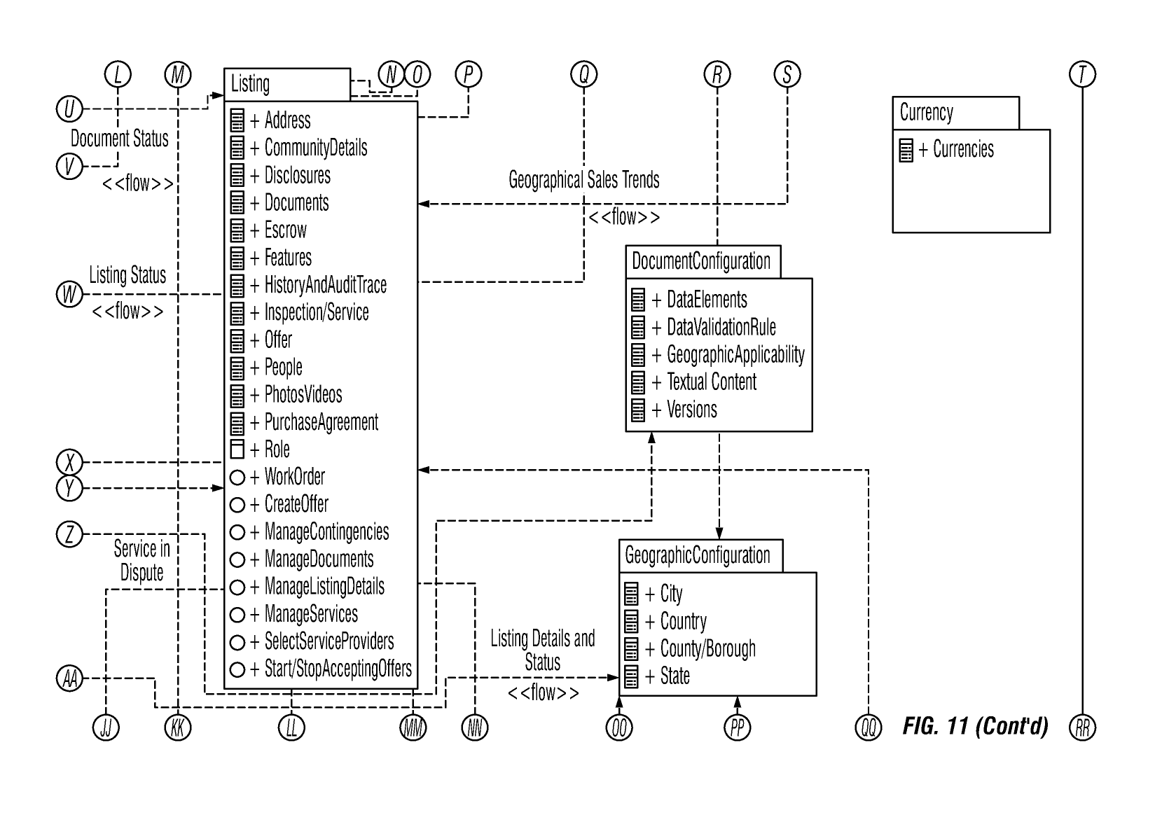

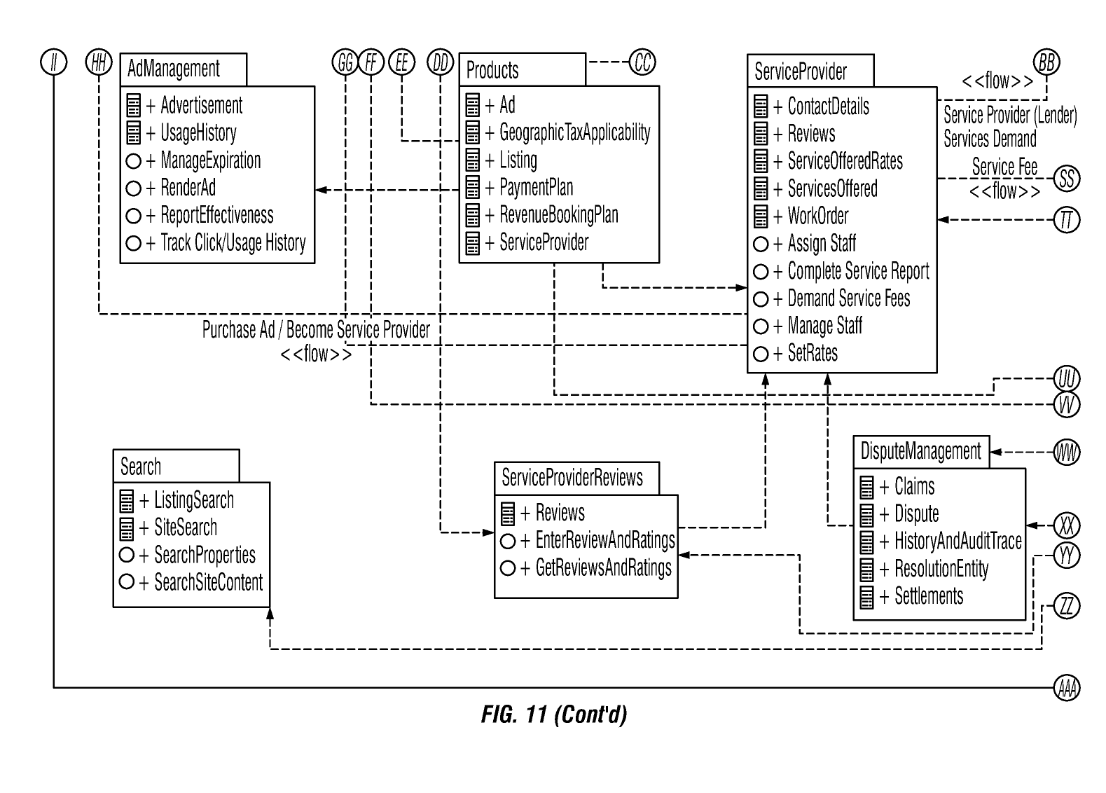

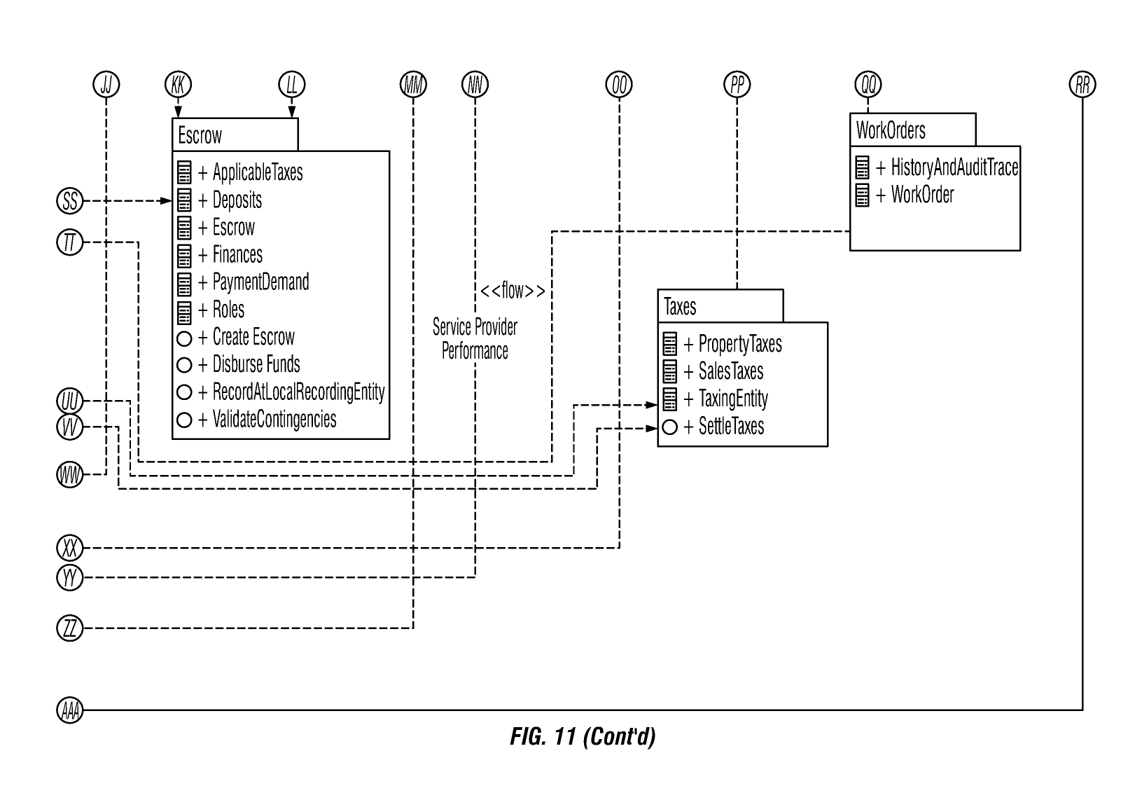

Although several of the important objects have been described above, there are many more objects in the system. FIG. 11 shows an object model that depicts flow between various objects, object properties and use cases according to an embodiment of the invention. The framework may be implemented with many more objects than those displayed in the model.

Listing Manager 152: may interact with a seller to receive information about a real estate listing and request that the Object Manager 140 create and maintain a Listing object 161.

Offer Manager 154: may interact with the buyer initially to specify the original terms of an offer to buy a property described in a real estate listing, and may request that the Object Manager 140 create and maintain an Offer object 164. The Offer Manager 154 may also interact with a seller and buyer to accept an offer, reject an offer, or create a counter-offer. An offer may be changed by adding services and indicating who will pay for the services.

Transaction Controller 153: directs the workflow for each property transfer transaction. It manages the state of each transaction. For each potential current state, there is a set of associated rules that determine when the state machine transitions from the current state to a different state. Determining that a transition may take place may include determining that a particular set of tasks has been completed or events have occurred in the system. A rule may comprise one set of tasks/events that are associated with a transition from State A to State B. Another rule may comprise a different set of tasks/events that are associated with a transition from State A to State C. An event may be generated upon task completion such as submitting a listing or an offer. Other events include cancelling a listing, rejecting or expiration of an offer, or failing to remove a contingency.

Platform Partner Interface 156: may register and interact with partner entities that outsource platform services such as a payment processing company for collecting platform fees, down payments, and deposits. For example, rather than including a payment processing service component within the system, the payment processing may be performed by an outside payment processing service such as on line check cashing (e.g. First Data, Wells Fargo, US Bank) or a credit card processing gateway (e.g. PayPal).

Another platform partner may be a title company retrieving current deed information on a property for platform use (may be a different company than the title company who is selected by the buyer for providing title insurance). Examples of information that a title company may provide about a property includes a parcel number, map information, current lender, last selling price, property tax, liens, homeowners insurance on the property, etc.

Another partner may be a credit bureau for checking credit worthiness or performing authentication on participants in a property transaction. A credit bureau may provide credit information about buyers that may be used by sellers when deciding to accept an offer or by lenders when deciding to issue a mortgage.

A lender may partner with the system allowing buyers to apply for a mortgage within the system as well as track the status of the loan approval within the system. This not only may provide visibility of the loan process to the buyer, but may also allow for automatically detecting a loan approval event that may result automatically removing a contingency.

Service Provider Interface 155: manages the registration and interaction with service providers as well as the creation and management of service orders 163. The system may also connect with service providers with whom users of the system interact directly. The system may list available providers with service and rating information, initiate contact between a user and a provider, manage a contract between the user and the service provider, manage payment for service rendered, and store documents related to the service provided. For example a contractor may create an inspection report which may be stored with the work order as part of the listing, and service providers terms and conditions when providing service or a catalog detailing service components may be stored by the document manager 142.

Purchase Agreement Manager 158: may request that Object Manager 140 create and maintain a Purchase Agreement object 165 and interact with the user to add/remove contingencies to/from a Purchase Agreement Object, and create corresponding Addenda for a Purchase Agreement document.

### Workflow

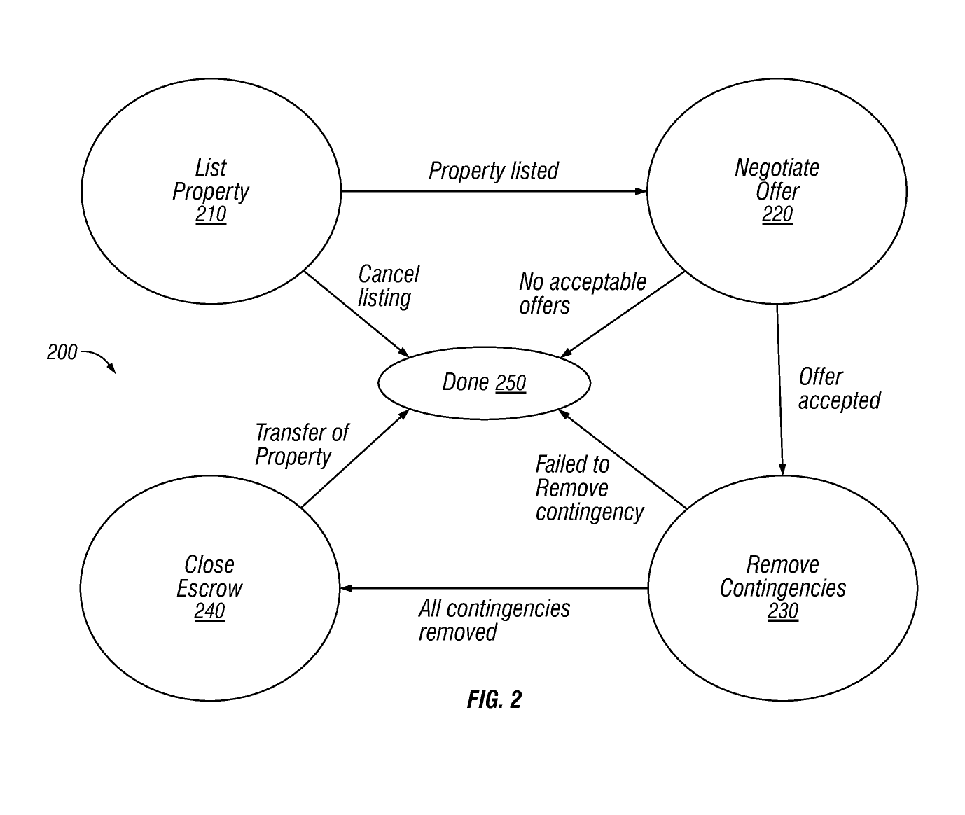

The platform supports a workflow that reflects the lifecycle of a property transfer transaction. FIG. 2 is a high level transition diagram showing the main state transitions of a property transfer transaction, according to an embodiment of the invention. In the List Property state 210, the seller interacts with the system to create a listing for the property including textual, photographic, and/or video description of the property for sale. The listing also includes an asking price, an amount of deposit required, and any special offers or contingencies. A special offer may be an enticement to buyers such as assumability of an attractive mortgage, willingness to rent back, or other incentives to buy the property. A contingency may be one or more circumstances or conditions, which if not met, allows one of the parties of the contract to break the purchase agreement. For example, the buyer might require that fulfilling the terms of the purchase agreement is contingent upon getting funding or successfully selling their current house. Although many contingencies are specified at the time of finalizing and accepting an offer, any seller's non-negotiable requirements for selling the property may be presented as part of the listing in order to attract only those buyers who would find the requirement acceptable. The listing may also include a schedule for open houses as well as a link to schedule a view/tour of the property.

As the seller is assembling and entering the information to create a listing, the seller may consult information provided by the platform. For example, the platform may provide a link to a website providing the sale prices for properties recently transferred in the neighborhood, or may provide listing for professionals who stage houses for sale. A consultant may be hired to advise how to prepare the house for sale and how best to construct the listing.

When all of the information for the listing is entered into the system, the seller may elect a means of advertising the property such as the traditional Multiple Listing Service, a property sale website, or other advertising mechanisms. In an embodiment of the invention, only a minimal amount of information is required from the seller to create a listing and make the listing available for buyers to view, even if other necessary information is provided after the listing is submitted and made public.

One of the issues with selling property online is the ability to determine that the seller actually owns the property being sold, and that the person who has established an account with the system is the same person whose name appears on the deed to the property. Within a short period of time after the listing is made public, the seller needs to be authenticated as having the authority to sell the property in the listing. The system may provide at least two facilities for addressing this issue. First, a title company with access to electronic property deeds may be a platform partner and may retrieve the owner information for a given address and lot specified in the listing. Subsequently, the seller who has an account with the system may provide authenticating information, such as a social security number, passport, driver's license, credit card accounts, bank accounts, etc. One or more platform partners may determine a confidence level for each piece of authenticating information. Experian is an example of a company that offers an identity check score that is analogous to a credit rating score. For example, an authentication service may assign a confidence score that each piece of provided information is accurate and consistent with the other information provided. The confidence score may be a probability expressed as a percentage or a decimal, or the confidence score may be an absolute number on scale from 0 to a highest confidence score similar to a credit rating, which is expressed as a number between 0 and 800. The platform may use the seller's identity information confidence ratings to determine whether to allow the seller to list their property on the platform. In addition, the platform may have a configured threshold for the identity confidence score, and when a score for a particular piece of information falls below the configured threshold, the platform may require that a manual process be used as an adjunct to the online authentication process for authenticating that particular piece of information. For example, the seller may have to contract with a notary service provider. If a seller fails to authenticate, the listing may be removed from the system. Once listed, the workflow state changes to Negotiate Offer 220, and the system prepares to accept offers for the property.

Once the property is listed, the system may allow buyers to view the listings. If no offers are received, or none of the offers received are acceptable to the seller, the seller may decide to unlist the property, lower the price, or provide other incentives. Unlike when working with a REA, the seller has no contractual obligation to list the property for any minimum amount of time. When the seller decides to remove the listing for the property, the real estate transaction ends (Done 250). Seller may again list the property at a more suitable time.

While in the Negotiate Offer 220 state, a buyer interested in a listed property may interact with the system to prepare an offer to purchase the property. An offer may include the amount of money the buyer is willing to pay for the property, the amount of the down payment offered, any special incentives to accept the offer such as an offer to pay cash, pre-qualification for a mortgage, high credit rating, etc. and buyer contingencies such as the buyer requires being released from the contract if funding falls through or if the inspection reports shows certain defects like flood or earthquake damage, mold, extensive termite infestation, or other major defects.

A buyer who is potentially interested in placing an offer on a property may also use the service provider and informational links provided by the platform. For example, the buyer might use links to information on quality of public schools or location of sex offenders in the neighborhood. A buyer who intends to change the house significantly or build a house on an empty lot might also hire a consultant knowledgeable about city codes for remodeling if the intention is to change the house after purchase. Such a consultant could provide information on the ease of and expense of obtaining permits, the impact of improvements on property taxes, and rough estimates of the cost of such improvements or access and expense of tying into utilities such as water, sewer, gas, electric, and Internet for building a new house on an empty lot.

While in the Negotiate Offer 220 state, sellers may view all of the offers received within a reasonable time window, and choose to negotiate a contract with the most attractive offer or to decline all offers. When the seller chooses an offer, the transaction may transition to the Remove Contingencies 230 state. Because the seller may only pursue one offer at a time, there can only be one purchase agreement at a time associated with any listing, and thus, if one offer falls through, a subsequent offer may be viewed as a continuation of the property transfer transaction (seen from the seller's point of view). Alternatively, each new purchase agreement may be viewed as a separate sub-transaction.

A purchase agreement is a contract between the buyer and the seller regarding the terms and conditions of transferring the property from the seller to the buyer. During the Remove Contingences State 230, the seller and buyer perform tasks specified in the purchase agreement to remove contingencies, and they negotiate and document additional terms and conditions as the need arises. For example, a property inspection may not be performed until after a purchase agreement is signed, but if the inspection identifies termite damage, the buyer and seller need to add an addendum to the purchase agreement to state who will pay for the repair. Any changes to the Listing by the seller after a purchase agreement is created may trigger an automatic addendum for approval from buyer. The system records the details of the negotiations. Because the negotiations are conducted via the system, every decision is documented in “writing” (stored persistently). As new issues arise that were not covered by the original purchase agreement, additional addenda may be initiated by either buyer or seller and accepted or rejected by the other party. If the seller and buyer cannot agree on the terms and conditions, the sub-transaction may transition to the Done 250 state and the main transaction may return to waiting for additional offers in the Negotiate Offer 220 state.

During the Remove Contingencies State 230 the seller and buyer engage in activities required to meet all terms of the agreement. For example, inspectors may be hired to write a report on the condition of the property, and the buyer may apply for a mortgage and select a lender. An escrow account may be created, a title insurance company selected, and a title report generated. If problems are discovered by the inspectors, contractors may be hired to perform repairs. The system may support requesting bids from among all service providers or just a selected set of service providers that are known to and integrated into the system. For example, a seller might select 3 contractors for removing dry rot and termite damage from a wooden deck and invite these 3 contractors to bid for the work, after which, one contractor is selected. Thus, the contract with a service provider may be created and recorded by the system, and payment may be made through the escrow account, which may not be released until the terms of the contract are met. In an alternative embodiment, the platform partner interface 156 may utilize a payment processing partner to pay a service provider directly without channeling the money through the escrow account. Once all contingencies have been removed and the terms of the purchase agreement are met, the transaction transitions to the Close Escrow state 240.

During the Close Escrow state 240, the escrow account receives funds from buyer(s) and lender(s), legal documents are agreed upon (electronically signed) and filed with the county government, the escrow service provider disburses funds to the seller and potentially hired service providers, pays taxes and demands, and instructs seller to transfer possession of the property to the buyer. If the mortgage contract requires an impound account, funds may be deposited into the lender's impound account to pay for taxes, property insurance, and interest pre-payments.

### Platform System Business Model

In an embodiment of the invention, the system host may charge service providers a yearly membership fee for being listed in the system. The service providers may additionally or alternatively pay a commission in the form of a percentage of the cost of the work or a flat fee for each successful referral. In an embodiment, a seller may pay for creating the listing, similar to paying for advertising. A service provider may pay (purchase) for ad space on the platform. In an embodiment, the system operator/host may collect a fee at the close of escrow, similar to how a REA is paid today. However, the fee need not be a percentage of the property selling price.

In an embodiment, the system itself provides NO ADVICE or INSTRUCTIONS to buyer or seller. The system merely provides infrastructure for communication, transparency of transaction state between buyer and seller, access to reference information, and non-repudiation. Advice may be provided by licensed or certified service providers who are only identified by the system, but the system is not liable for the content of the advice. In an alternate embodiment, the operator/host of the system may have a real estate licensed staff and provide certain type of the services as an integral part of the platform. Sellers and buyers may choose to hire specialized advisors, legal counsel, or real estate counsel as part of the transaction.

### Tool Functionality

A user interacts with a tool for engaging in real-estate transactions using the self-service real estate framework. The description of the tool functionality is organized around the main objects supported in the system.

### Creating a Listing

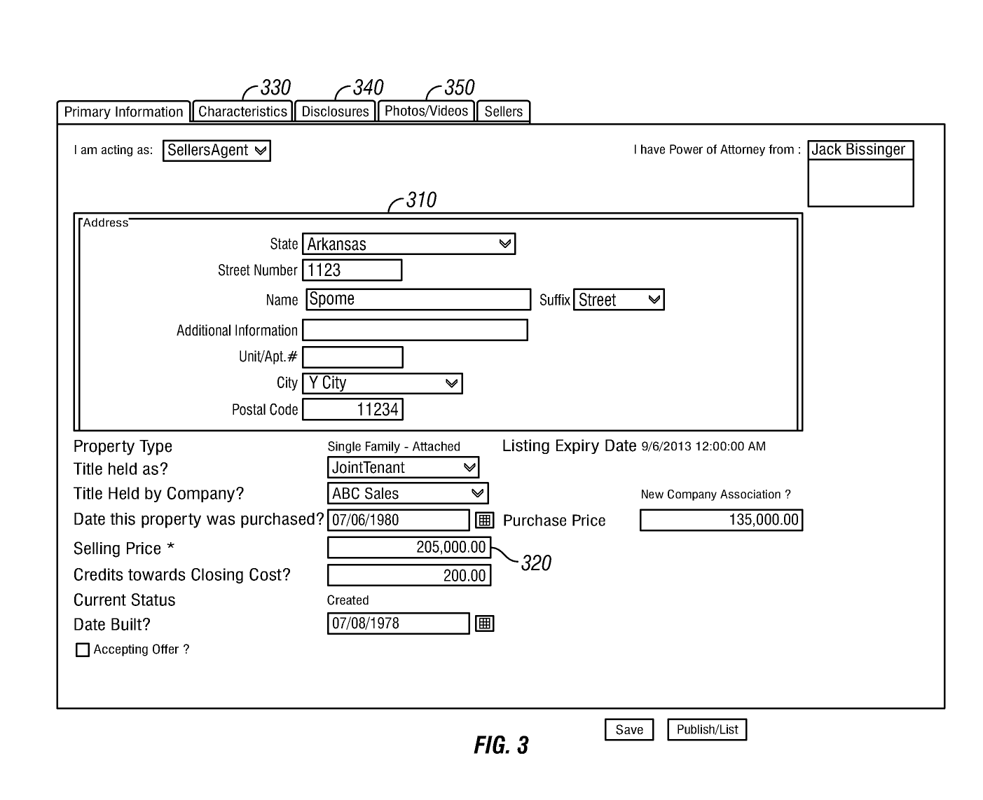

FIG. 3 is an example screenshot of a seller's user interface for creating a new listing. The seller may be prompted to specify information about the new listing such as property address 310 and selling price 320. Additional information about the property, which when added, may be displayed on the Characteristics tab 330, Disclosures tab 340, and PhotosNideos tab 350.

A listing may be in one of the following states: “Created/Pending Submission”, “Submitted/Pending Review”, “Cancelled”, “Declined”, “Revoked”, or “Expired” or “Closed.” A listing that has been created but not yet submitted may be cancelled. A listing that has been submitted but has not received offers may be revoked, and a listing that has received offers may be closed. An expired listing may no longer show up in the search results and no new offers are accepted for that listing.

### Searching for a Properly

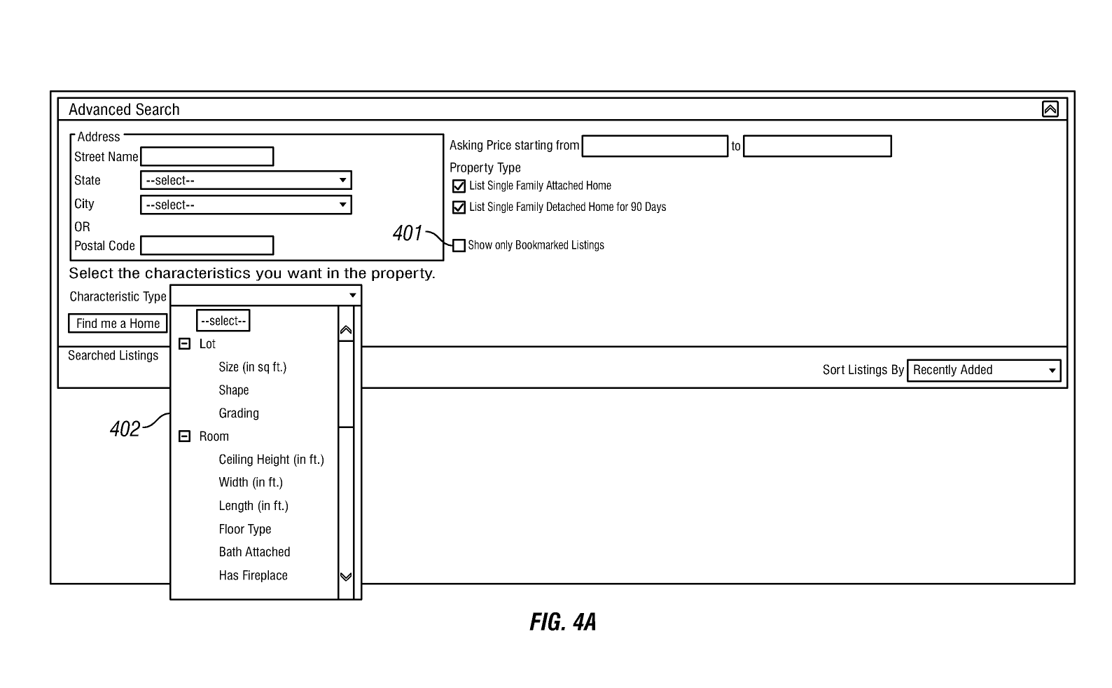

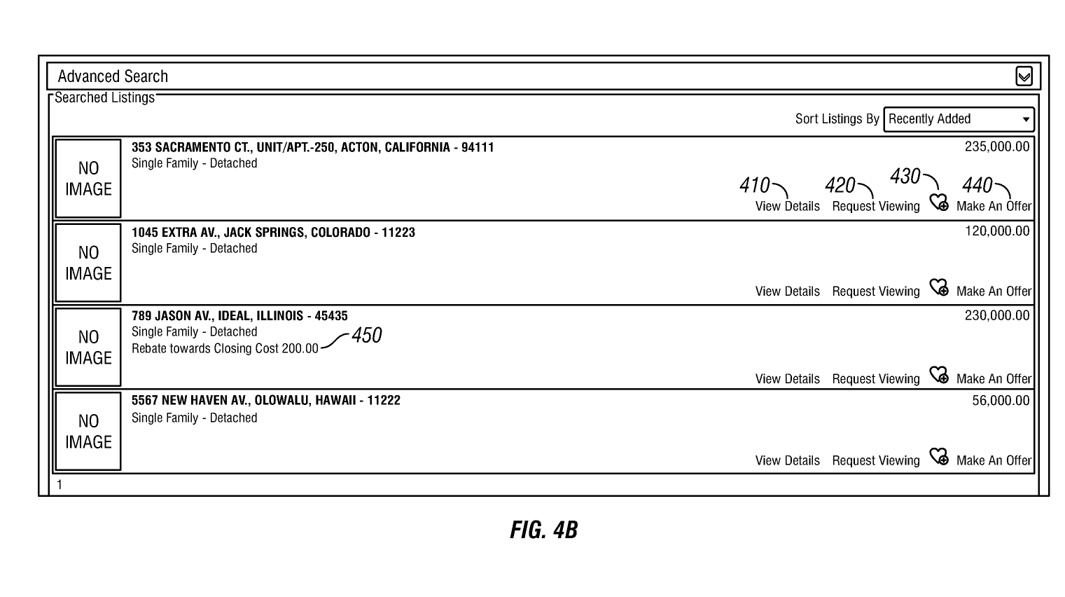

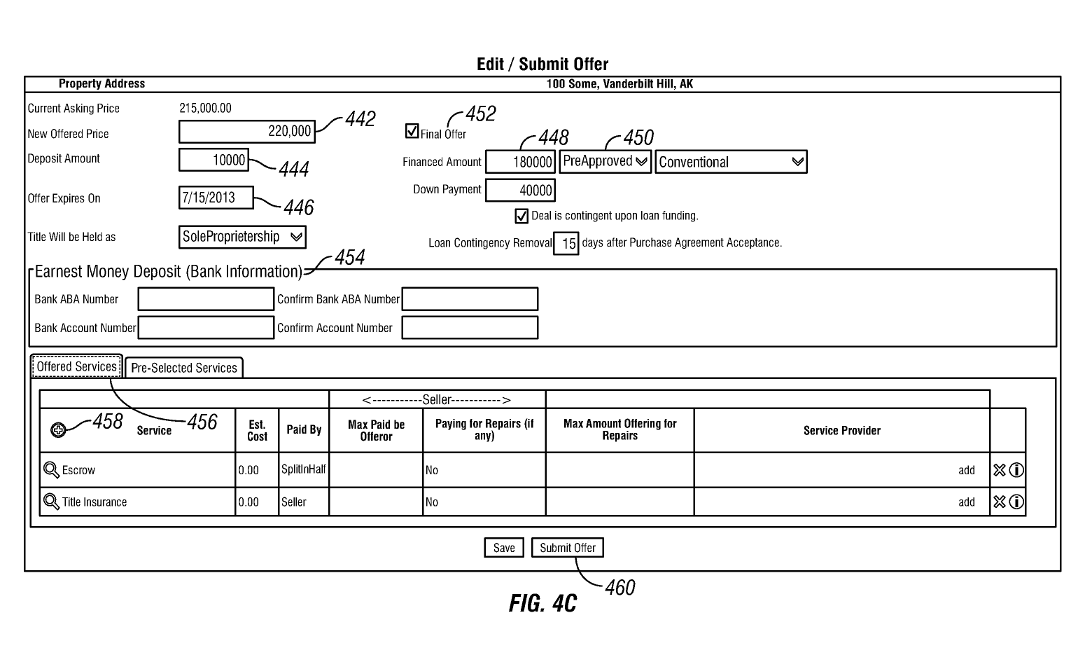

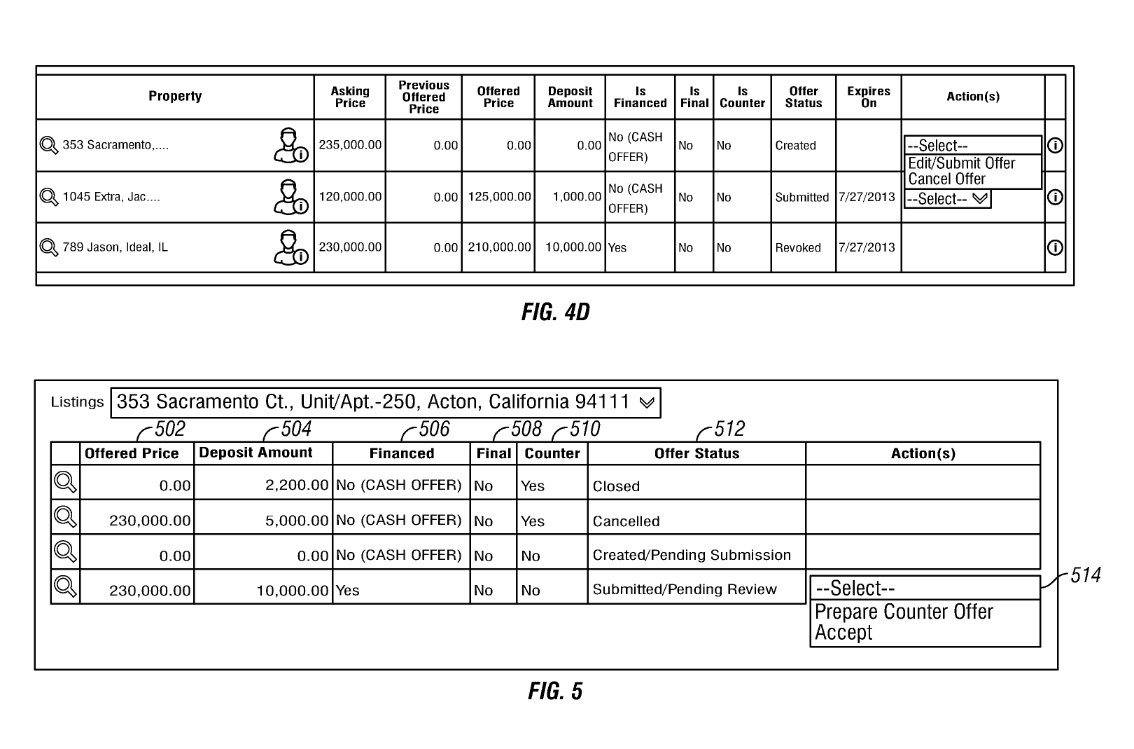

FIG. 4a is an example screenshot of a search interface for buyers to search for property listings. The screen shots shows many of the different attributes of a property that may be searched for including characteristics such lot and room attributes shown in the scrolled box (402). A checkbox 401 labeled “Show only Bookmarked Listings” allows searching only those properties that have already been bookmarked, rather than searching across all listings in the system.

FIG. 4b is an example screenshot of search results for a buyer searching for listings. In response to a buyer searching for single family homes with an asking price of less than $240,000. Four listings are identified. The first listing displayed is a property in California with an asking price of $235,000. Each listing may have a “View Details” link 410, which when traversed, presents some or all of the listing information about the property. A “Request Viewing” link 420, when selected, nay present a partially-completed form requesting to visit/tour the property. Upon completion of the request to view form, the completed form may be delivered to the property seller. A viewing is usually a physical tour of the property, but may alternatively comprise access to a recorded or live video tour. A heart-shaped icon 430 may be selected to add this listing to the prospective buyer's favorites list for later review. A “Make An Offer” link 440, when selected, may present a partially-completed form for making an offer on the property. The listing may include an indication 450 from the seller that a rebate is offered towards the closing cost as seen, for example, with the listing from Illinois.

### Creating an Offer

FIG. 4c is an example screenshot of a user interface form for creating an offer for a listed property, according to an embodiment of the invention. The form may be pre-populated with the asking price of the selected property. The buyer may be prompted for input to add to the offer including, but not limited to, offer price 442, deposit amount 444, date offer expires 446, how much of the of price is to be financed 448, whether financing is pre-approved 450, whether this is a final offer or open to further negotiation 452, and bank account information 454 for funding a deposit for the property.

In addition, the buyer may specify services relevant to the real-estate transaction that they are willing pay for such as standard or non-standard inspections/services, or may specify that a particular service provider must be used for some portion of the transaction, such as a particular escrow or title company. On the “Offered Services” tab 456, additional offered services may be selected by clicking on the plus sign at the left of the panel (at reference number 458). That may bring up a list of service providers in a form, from which the buyer may select a service type. Once a service type is selected, a list of service providers that provide the selected service type may be shown. The “Submit Offer” button 460 may deliver the offer information to the seller.

FIG. 4d is an example screenshot of a buyer's user interface form for managing one or more offers, according to an embodiment of the invention. An offer that was previously submitted may be cancelled. An offer that was previously created but not yet submitted may be submitted from this form.

### Accepting an Offer

FIG. 5 is an example screenshot of a seller's user interface form for presenting one or more offers received for a particular property, according to an embodiment of the invention. For each offer, the following information may be summarized in a table: offered price 502, deposit amount 504, whether the offer is financed 506, whether the offer is final 508, whether the offer is a counter-offer 510, and the offer status 512. For active offers, a list of seller actions 514 may be displayed for selection. For example, a seller may elect to accept an offer or to make a counter-offer. Selecting an offer in the list may present more or all details of the offer.

If the offer is acceptable to the seller, then the seller may select the “Accept” action. If the offer is interesting, but needs some revision, the seller may select “Prepare Counter-Offer” to propose changes to the buyer. The form for creating a counter-offer may look identical to the form for creating an original offer, such as shown in FIG. 4b. As a result of entering a counter-offer, the buyer may see the counter-offer appear in their offers list. A seller may revoke a counter-offer when the counter-offer status is “yes” and the Offer status is “Submitted/Pending Review.” This process of making counter-offers may continue between buyer and seller until one of them accepts or rejects the current offer. In an embodiment, color coding of the offers may be used to distinguish those offers made by a buyer awaiting response from a seller and those counter-offers made by a seller awaiting approval from a buyer. Each offer's state is listed in the Offer Status column 512 and may be one of “Created/Pending Submission”, “Submitted/Pending Review”, “Cancelled”, “Declined”, “Revoked”, or “Expired” or “Closed.” An offer that has been created but not yet submitted may be “Cancelled.” An offer that has been submitted but yet not accepted may be “Revoked.” A counter-offer may be “Declined.” An offer may have an expiration date, and past the expiration date the offer may have an “Expired” status.

### Creating a Service/Work Order

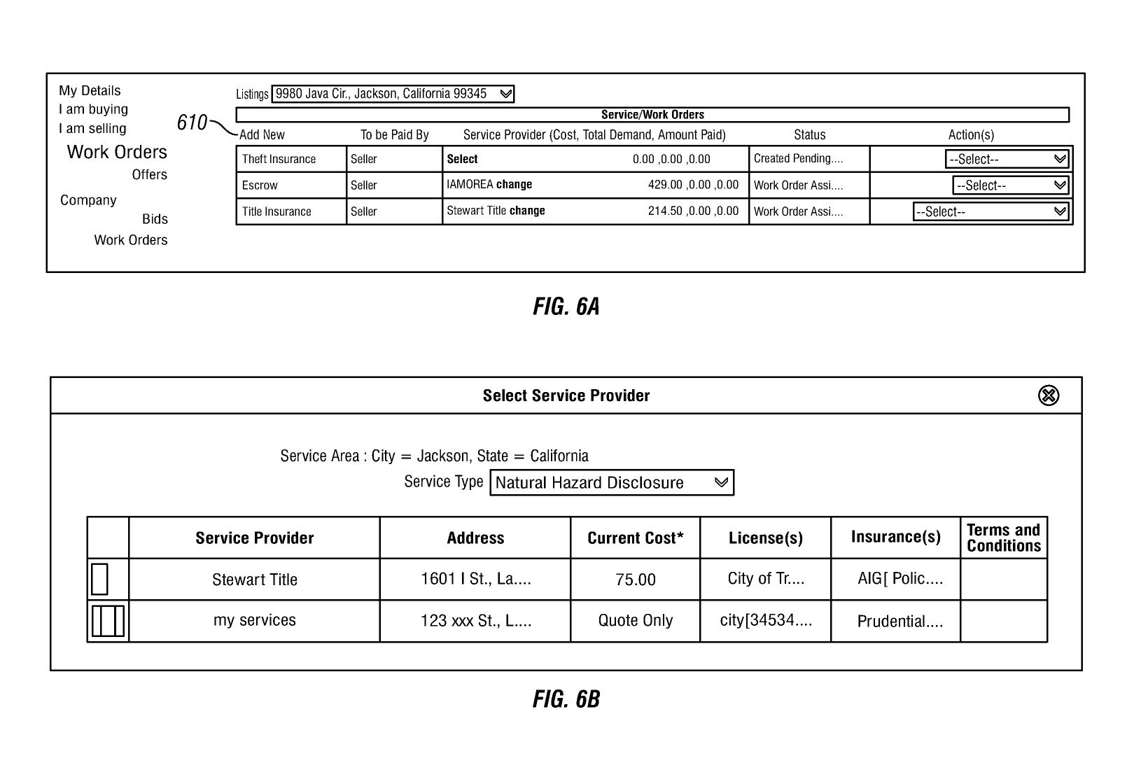

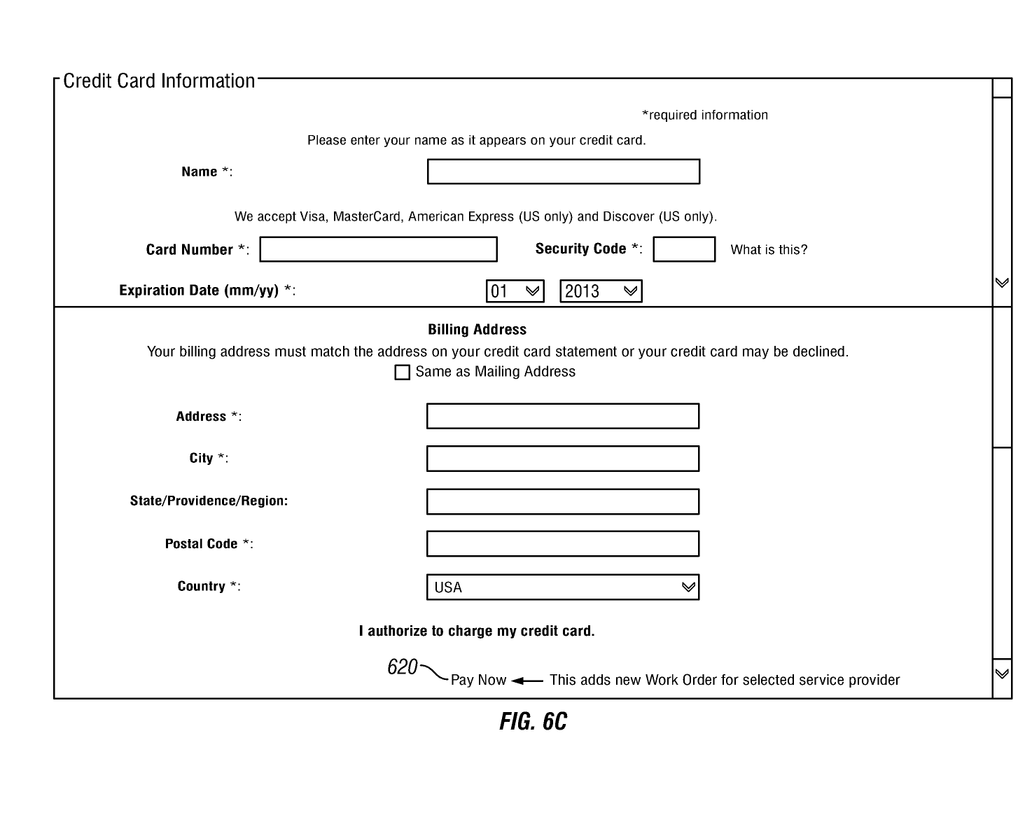

FIG. 6a is an example screenshot of a user interface form for listing work orders associated with a property. The form allows a client to create a service work order, according to an embodiment of the invention. When a buyer or seller (client) wishes to hire a service provider, the client may create a work order by clicking the “Add New” 610 option. The screenshot shown in FIG. 6b allows the user to select the type of service desired, then to select from a list of service providers of that desired type. Response to a work order may be solicited in several different ways: a) a client may request bids for a work order from all registered service providers in the system, b) a client may specify specific service providers from whom to invite bids, c) a client may submit a request for quote to a specific service provider. This may be useful when a service provider does not have published rates and the rate fluctuates greatly d) a client may or request a contract directly with a selected service provider in the system, e) the client may select a service provider and assign a work order without ever requesting bids, or f) the client may invite a service provider not listed in the system to join the system.

A set of service provider forms are used for processing bids (not shown in the figures). One screen may display all requested/invited bids. Once a bid is made, the service provider may track the status of outstanding bids in a separate user interface that lists all bids submitted by the service provider.

Service providers may be invited or requested to provide bids. When a client selects one of the bids, the service provider may be notified and a work order may be populated with the details of the agreement between the client and the service provider. FIG. 6c shows an example form for obtaining credit card information for paying for the service agreed to in the work order when the service provider wants payment before providing service. A service provider may alternatively accept payment on delivery of service or on Close of Escrow. Selecting the “Pay Now” 620 option adds the new work order for the selected service provider's bid.

If after a certain time period no bids are received or if none of the received bids are acceptable to the client, the work order may be cancelled or the client may select a different set of service providers from which to request bids or to invite one or more service providers not in the system to register as service provider and bid.

### Documents

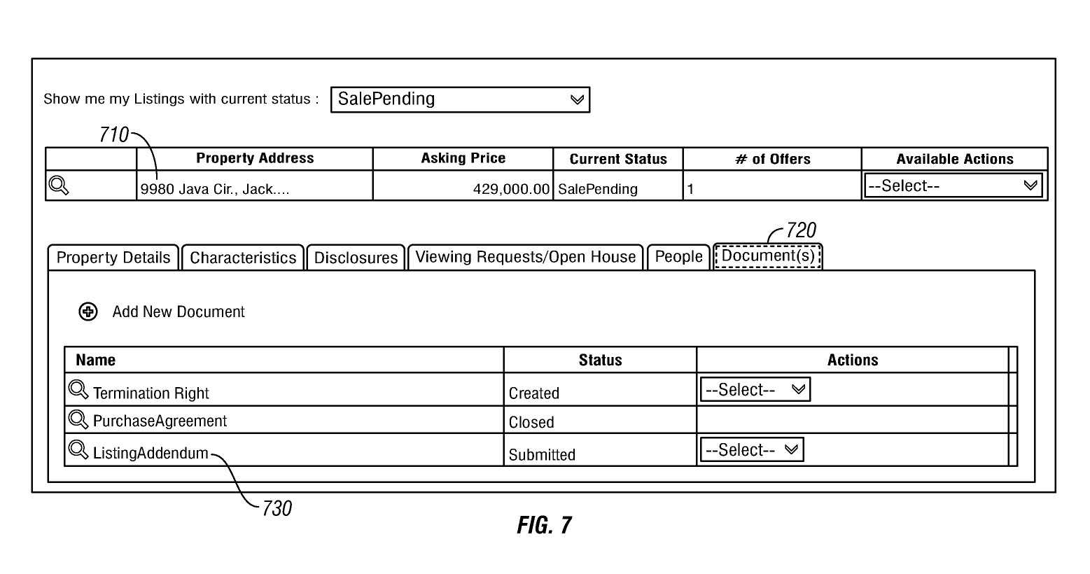

FIG. 7 shows a small example list of documents associated with a real estate transaction, according to an embodiment of the invention. Selecting the Document(s) tab 720, the documents associated with Property Address 710 may be displayed. For example, an addendum to the listing 730 may contain the changes relative to the original purchase agreement.

### Disclosures

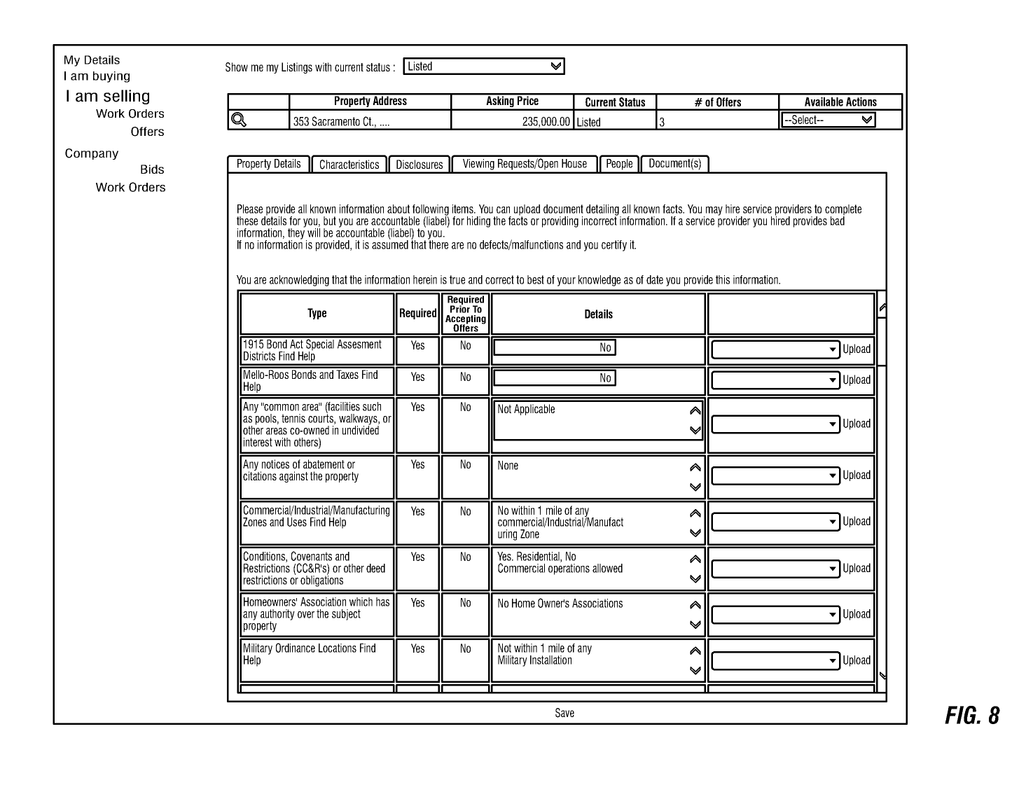

Disclosures made by the seller regarding the property may be viewed and downloaded in a screen such as shown in FIG. 8. The types of disclosures may be obtained from the Department of Real Estate and may serve to remind the seller of the kinds of disclosures needed. Examples of disclosures may include results of property inspections, title company reports, Conditions, Covenants, and Restrictions (CC&R's) pertaining to the neighborhood, property tax information, etc. The details column of the table may be filled in by the seller or by a service provider hired to act on behalf of the seller. Files may be uploaded as supporting documentation.

### Becoming a Service Provider

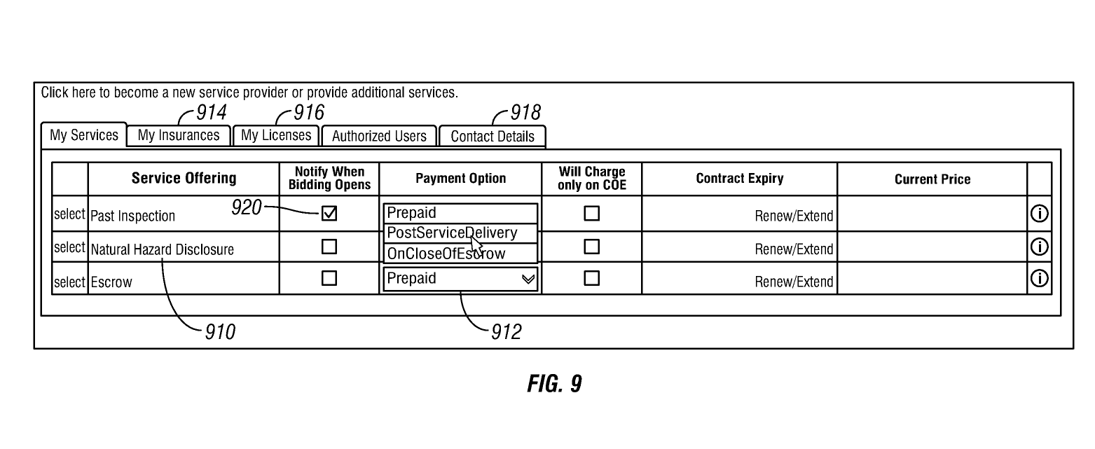

The tool also provides an interface for service providers to configure the services they offer through the platform. FIG. 9 shows the kinds of information that service providers may provide including the type of service offered 910, payment options accepted 912, insurance 914, licenses 916, and contact details 918. If a service provider checks the box in the column “Notify When Bidding Opens” 920, then the service provider may receive a notification when eligible to bid for a project requested by a buyer or seller.

### New Business Opportunities

As explained earlier, real estate agents provide a myriad of different services during the transfer of ownership of a property and are typically compensated based on a percentage of the final selling price. With the introduction of the system described herein, the business model for real estate agents may change dramatically. The system allows for the myriad of different services previously performed by an agent to be unbundled, individually contracted, and paid for separately. This allows the parties to the sale (buyer and seller) to select and pay for just those services they need, and not pay for services they do not need. For example, certain services may be performed by the buyer or seller on their own behalf, and for other services, a service provider may still be needed. However, by unbundling the services, a buyer/seller may hire the best service provider for the job. No agent can be the best at performing all the services they are paid to do, and multiple service providers can be hired to do just what each service provider does best.

The unbundling of services may be beneficial to a real estate agent as well, freeing them to focus on providing those services that they are most interested in and knowledgeable about. Also, with the traditional model, a real estate agent only gets paid if the sale closes, and all work invested in a property transfer is lost if the sale falls through. With the unbundled approach, a real estate agent may be hired to perform a certain specific tasks such as providing consulting or hosting an open house, and would be paid for performing that task regardless of the outcome, just as any other service provider would (such as a lawyer or building contractor). For example, an agent might be paid a fixed or hourly rate to review a draft purchase agreement document and provide feedback, just as a lawyer may review any contract and advise their client. Another example is that an agent may be hired to evaluate a set of offers to determine which would be the best to accept and what counter-offers should be made. An additional benefit of hiring an agent to perform a well-defined, discrete task is that the agent would no longer have a vested interest in the outcome. The agent would be free to advise the client according to the client's best interest without having a conflicting personal interest.

Outside of an open house, when selling a property where buyers are not necessarily escorted to the property individually and given a tour, alternative mechanisms may be needed to allow prospective buyers to view the properties in a way that does not put the seller's personal property or the real estate property at risk. This need may motivate additional services such as setting up surveillance cameras that may be monitored over the internet and providing an Internet-enabled lock box. An internet enabled lock box may be used to secure a front door of a house for sale where an expected code must be entered to unlock the door. The code may be remotely set. A prospective buyer may make an appointment to view the property at a certain time on a certain day, and the lock box may be programmed to allow entrance when provided by a code identified for just that appointment. A different code may be selected or generated at random for each appointment. Thus, only the expected buyer may have access to the property during their appointed time. The Internet-enabled lock box may be offered by a service provider through the system platform.

Another business opportunity provided by sellers using the system is the need for theft/vandalism insurance to cover loss resulting from potential buyers viewing the property. In a world where buyers are not necessarily escorted to the property and given a tour, the buyers themselves need to be more accountable. Access to the property may be screened, and the exact entry/exit of the house may be monitored, and an insurance policy may be sold to cover just the volume of viewing (for example, based on the total amount of time a viewer spends at or in the property or based on the number of viewers) during the time when the policy is in effect.

### Example Transaction

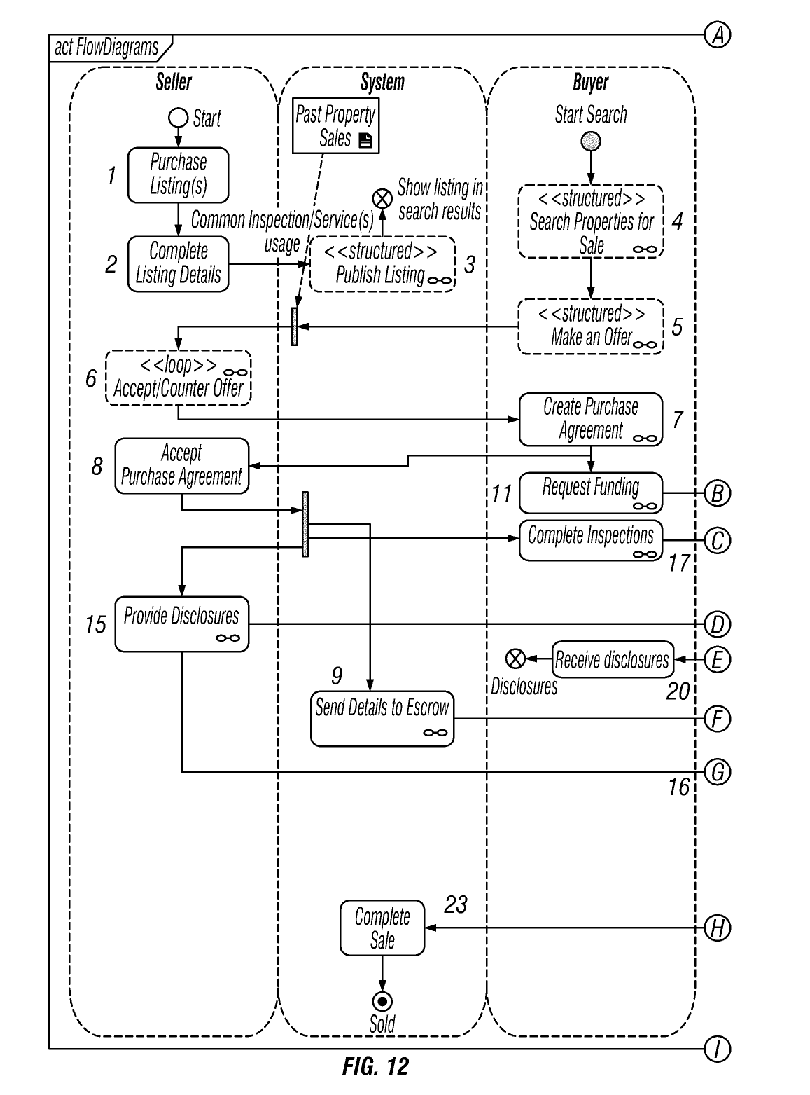

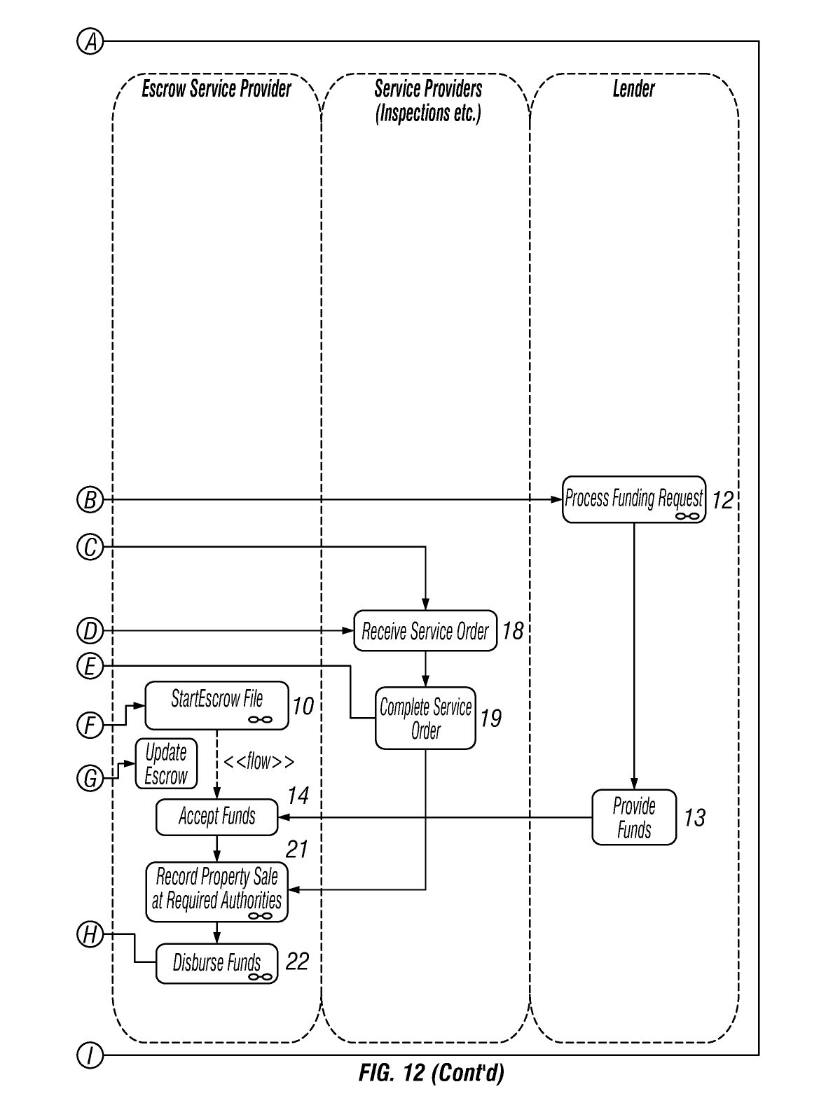

FIG. 12 is a flow diagram showing some of the steps of a simplified example real estate transfer transaction including a buyer, a seller, the platform system, an escrow service, a property inspector, and a lender, according to an embodiment. The system facilitates all the steps as described above.

In Step 1, the seller pays to create a listing on the system. In Step 2, the seller creates the listing and in Step 3 publishes the listing. In Step 4, a buyer searches for properties for sale, and the published listing appears in the search results. In Step 5, the buyer makes an offer for the listed property, and in Step 6 the seller either accepts the offer, or one or more counter-offers are made until one is accepted. In Step 7, the buyer creates a purchase agreement that captures the details of the listing and the offer, as well as any additional contingencies known at the time. In Step 8, the Purchase Agreement is accepted by the Seller.

Once the purchase agreement is created, buyer and seller can engage in separate and parallel activities. One parallel activity is establishing an escrow account. In Step 9, the system may send the details of the purchase agreement to the escrow service provider who starts the escrow file in Step 10.

In another parallel activity, the buyer requests funding from a lender in Step 11. In Step 12, the lender processes the funding request, and in Step 13 provides funds to purchase the property. In Step 14, the funds are received into the escrow account.

Although it is ideal for all disclosures to be included in the original Purchase Agreement, the seller may add disclosures after the Purchase Agreement is signed, and the buyer may approve or disapprove of the amended Purchase Agreement when a new disclosure is added. A seller may decide to hire a service provider to generate the information for a disclosure as seen in Step 18.

Another parallel activity is completing property inspections. In Step 17, the buyer creates a work order for an inspection and selects an inspector to perform the work. The Inspector receives the service order in Step 18, completes the inspection in Step 19, and issues a report to the buyer with the inspection findings in Step 20 that are also added to the disclosures. By this time all service providers have submitted their demands for payments to Escrow, if not already paid on or prior to delivery of service.

Once all contingencies are removed, such as all disclosures and funding received, the escrow service provider records the sale of the property and liens resulting from lending in Step 21 and disburses funds at Step 22. At Step 23, the system completes the sale.

### Exemplary Digital Data Processing Apparatus

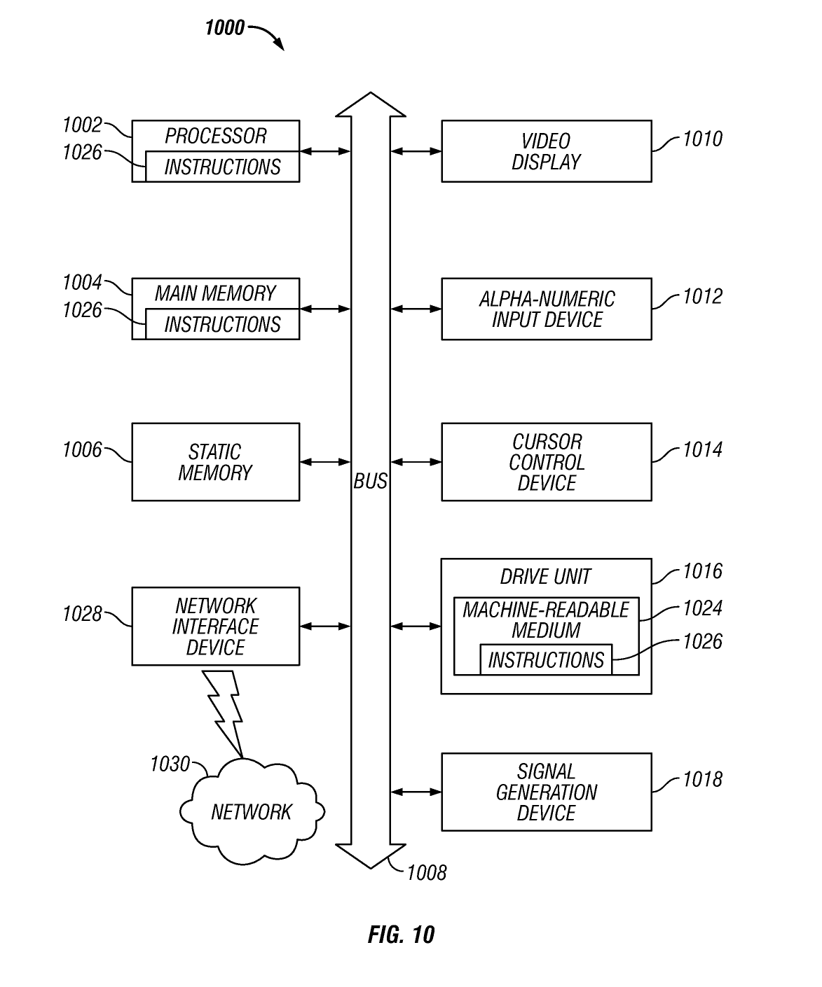

Embodiments of the invention may be implemented using a digital data processing apparatus. As a specific example, FIG. 10 Shows a digital data processing apparatus 1000. The apparatus 1000 includes a processor 1002, such as a microprocessor, personal computer, mobile phone or other mobile personal computing device, workstation, controller, microcontroller, state machine, or other processing machine, coupled to a digital data storage 1004. In the present example, the storage 1004 includes a fast-access storage 1006, as well as nonvolatile storage 1008. The fast-access storage 1006 may be used, for example, to store the programming instructions executed by the processor 1002. The storage 1006 and 1008 may be implemented by various devices. Many alternatives are possible. For instance, one of the components 1006, 1008 may be eliminated; furthermore, the storage 1004, 1006, and/or 1008 may be provided on-board the processor 1002, or even provided externally to the apparatus 1000.

The apparatus 1000 also includes an input/output 1010, such as a connector, line, bus, cable, buffer, electromagnetic link, network, modem, transducer, IR port, antenna, or other means for the processor 1002 to exchange data with other hardware external to the apparatus 1000.

Various instances of digital data storage may be used to embody the storage 1004 and 1008, and for other purposes. Depending upon its application, this digital data storage may be used for various functions, such as storing data, or to store machine-readable instructions. These instructions may themselves aid in carrying out various processing functions, or they may serve to install a software program upon a computer, where such software program is then executable to perform other functions related to this disclosure.

In any case, the storage media may be implemented by nearly any mechanism to digitally store machine-readable signals. One example is optical storage such as CD-ROM, WORM, DVD, digital optical tape, disk storage, or other optical storage. Another example is direct access storage, such as a conventional “hard drive”, redundant array of inexpensive disks (“RAID”), or another direct access storage device (“DASD”). Another example is serial-access storage such as magnetic or optical tape. Still other examples of digital data storage include electronic memory such as ROM, EPROM, flash PROM, EEPROM, memory registers, battery backed-up RAM, etc.

An exemplary storage medium is coupled to a processor so the processor can read information from, and write information to, the storage medium. In the alternative, the storage medium may be integral to the processor. In another example, the processor and the storage medium may reside in an ASIC or other integrated circuit.

### Other Embodiments

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

Furthermore, although elements of the invention may be described or claimed in the singular, reference to an element in the singular is not intended to mean “one and only one” unless explicitly so stated, but shall mean “one or more”. Additionally, ordinarily skilled artisans will recognize that operational sequences must be set forth in some specific order for the purpose of explanation and claiming, but the present invention contemplates various changes beyond such specific order.

1. A system for providing transparency in a multi-party real estate transaction, the system comprising:
a processor configured as a transaction controller that tracks a current state of a real estate transaction, wherein the processor executes a state machine comprising rules that define:
a plurality of states of the real estate transaction;
wherein each state of the plurality of states for the real estate transaction is associated with one or more tasks, and the one or more tasks associated with said each state are directed to one of:
placing a property for sale;
making an offer on the property;
negotiating terms of a purchase agreement, wherein the purchase agreement comprises contingencies;
removing the contingences from the purchase agreement; or
closing escrow;
for said each state, a set of tasks, which when completed, cause the real estate transaction to change from one state to another state; and
a processor configured as a user manager that assigns one or more roles to each user of the system, wherein user roles include at least buyer, seller, and service provider;
wherein the user manager maintains an association between a user role and one or more tasks, wherein a user having the user role has permission to perform said one or more tasks;
persistently recording data elements associated with completed tasks that support the resolution of a legal dispute;
a processor configured as a service provider interface that manages service provider registration, distributing requests for bids, receiving bids on a work order, tracking progress on work contracted through the service provider interface;
wherein each of said tasks is performed by said processor autonomously for the multiple parties of the real estate transaction and without the involvement of a real estate agent or broker.

2. The system of claim 1, the system further comprising a real estate listing manager that is configured to receive information from each of a plurality of sellers about a corresponding property for sale, and configured to provide information to a plurality of buyers about one or more properties for sale.

3. The system of claim 1, wherein the service provider interface maintains an interface with a plurality of service providers that collectively provide service types including a plurality of:
title insurance;
mortgage lending;
an escrow account;
real estate legal advice;
property inspection;
property appraisal; and
tax advisor.

4. The system of claim 3, wherein the service provider interface provides a user with information about a service provider including at least:
price;
delivery time;
insurance coverage; and
license status.

5. The system of claim 1, the system further comprising:
an infrastructure partner interface configured to provide access to services including at least:
Internet Search,
Security Services; or
Data Services.

6. The system of claim 1, wherein tasks associated with the state of making an offer include:
a buyer making an offer on a seller's listed property;
the seller making a counter-offer to the buyer's last offer;
the buyer making a counter-offer to the seller's last counter-offer;
the buyer or the seller accepting an offer;
specifying the details of a purchase agreement; and
automatically generating the purchase agreement document.

7. The system of claim 1, wherein the transaction controller is further configured to support users performing tasks including at least:
contracting for a service from a service provider;
accepting, rejecting, or disputing service provider deliverables; and
paying the service provider for the contracted services directly or through an escrow account.

8. A computer-implemented method for providing transparency in a multi-party real estate transaction, the method comprising:
without participation of a real estate agent, performing:
tracking a current state of a real estate transaction using a state machine comprising rules that define:
a plurality of states of the real estate transaction;
wherein each state of the plurality of states for the real estate transaction is associated with one or more tasks, and the one or more tasks associated with said each state are directed to one of:
placing a property for sale;
making an offer on the property;
negotiating the terms of a purchase agreement, wherein the purchase agreement comprises contingencies;
removing the contingences from the purchase agreement; or
closing escrow;
for said each state, a set of tasks which when completed cause the transaction to change from one state to another state; and
assigning one or more roles to each participant in the real estate transaction, wherein a set of participant roles includes at least buyer, seller, and service provider;
defining for each task, one or more participant roles of the set of participant roles that are given permission to perform said each task;
defining requirements for completing a task, wherein requirements include fulfilling legal requirements associated with the task;
receiving a registration request from a service provider;
distributing requests for bids to registered service providers;
receiving bids on a work order;
receiving a request to accept a particular bid; and
tracking progress on work performed based on the particular bid being accepted.

9. The computer-implemented method of claim 8, the method further comprising:
providing a list of mortgage lenders, and receiving in response, one or more mortgage lenders from whom to solicit bids; and
sending out request for bids to the one or more mortgage lenders.

10. The computer-implemented method of claim 8, the method further comprising:
determining that all tasks associated with negotiating the terms of the purchase agreement have been successfully completed; and
responsive to determining that all tasks associated with negotiating the terms of the purchase agreement have been successfully completed, transitioning to the state of closing escrow.

11. The computer-implemented method of claim 8, the method further comprising:
determining that all contingencies have been removed from the real estate transaction for the property;
receiving payment for the property; and
providing a buyer with a deed to the property.

12. The computer-implemented method of claim 8, the method further comprising:
receiving details about a particular real estate property for sale, and adding the real estate property to a list of properties for sale;
providing a list of offers for the particular real estate property;
receiving a selected particular offer from the list of offers;
receiving from a participant of the real estate transaction a counter-offer to the selected particular offer; and
notifying the participant that the counter-offer to the particular offer has been accepted.

13. The computer-implemented method of claim 8, the method further comprising:
providing a search interface for identifying appropriate service providers;
receiving a selection of a service provider; and
receiving a report from the service provider.

14. The computer-implemented method of claim 8, wherein:
persistently recording data elements associated with completed tasks comprises recording information including at least time and date information and details of every task performed by any participant in a real estate transaction.

15. A non-transitory computer-readable storage medium storing instructions, which when executed, cause one or more processors to perform:
tracking a current state of a real estate transaction using a state machine comprising rules that define:
a plurality of states of the real estate transaction;
wherein each state of the plurality of states for the real estate transaction is associated with one or more tasks, and the one or more tasks associated with said each state are directed to one of:
placing a property for sale;
making an offer on the property;
negotiating the terms of a purchase agreement, wherein the purchase agreement comprises contingencies;
removing the contingences from the purchase agreement; or
closing escrow;
for said each state, a set of tasks which when completed cause the transaction to change from one state to another state; and
assigning one or more roles to each participant in the real estate transaction, wherein a set of participant roles includes at least buyer, seller, and service provider;
defining for each task, one or more participant roles of the set of participant roles that are given permission to perform said each task;
defining requirements for completing a task, wherein requirements include fulfilling legal requirements associated with the task;
receiving a registration request from a service provider;
distributing requests for bids to registered service providers;
receiving bids on a work order;
receiving a request to accept a particular bid; and
tracking progress on work performed based on the particular bid being accepted.

16. The non-transitory computer-readable storage medium of claim 15, further comprising instructions, which when executed, cause the one or more processors to perform:
determining that all tasks associated with negotiating the terms of the purchase agreement have been successfully completed; and
responsive to determining that all tasks associated with negotiating the terms of the purchase agreement have been successfully completed, transitioning to the state of closing escrow.

17. The non-transitory computer-readable storage medium of claim 15, further comprising instructions, which when executed, cause the one or more processors to perform:
receiving details about a particular real estate property for sale, and adding the real estate property to a list of properties for sale;
providing a list of offers for the particular real estate property;
receiving a selected particular offer from the list of offers;
receiving from a participant of the real estate transaction a counter-offer to the particular offer; and
notifying the participant that the counter-offer to the particular offer has been accepted.

18. The non-transitory computer-readable storage medium of claim 15, further comprising instructions, which when executed, cause the one or more processors to perform:
receiving a buyer's deposit or down payment; and
sending the deposit or down payment to an escrow account created by the seller, wherein receiving and sending the deposit or down payment is performed electronically.
